(19) United States
(12) Patent Application Publication
(10) Pub. No.: US 2018/0240191 A1
(43) Pub. Date: Aug. 23, 2018

(54) System and Method for asset backed crypto-currency

(71) Applicant: Terry Aronson, Hallandale Beach, FL (US)

(72) Inventor: Terry Aronson, Hallandale Beach, FL (US)

(21) Appl. No.: 15/888,845

(22) Filed: Feb. 5, 2018

Related U.S. Application Data
(60) Provisional application No. 62/454,093, filed on Feb. 3, 2017.

(51) Int. Cl. G06Q 40/06; H04L 9/08; G06F 21/64; G06F 17/30; G06Q 10/08; G06Q 20/38

(52) U.S. Cl. CPC G06Q 40/06; H04L 9/0894; G06Q 20/3823; G06F 17/30283; G06Q 10/083; G06F 21/645

(57) ABSTRACT

A system and method for providing an asset based valuation for a novel online cryptocurrency.

### INDEX TO RELATED APPLICATIONS

This Application is a non-provisional of and claims benefit to U.S. Provisional Patent Application Ser. No. 62/454,093 filed Feb. 3, 2017 the disclosure of which is incorporated herein be reference in its entirety.

### BACKGROUND OF THE INVENTION

Currently, currencies used online have no hard backing for valuation. The system and method of the present invention addresses this deficiency. Additionally, cryptocurrencies used as “fundraising vehicles” have little or no “asset backing”.

### SUMMARY OF THE INVENTION

In one embodiment, the present invention is embodied in what will be described herein as the OZcoin system. Although the various embodiments and examples demonstrate use of gold as an asset for backing the cryptocurrency, it is contemplated and understood that any asset is used 2 0 including, but not limited to precious metals, exchange traded commodity, physical goods inventory, or combinations thereof. Further, the “100% asset backed cryptocurrency” means that ONLY a limited number of crypto-coins “tokens” will be issued and “linked” to the “asset”.

For example: The “100% gold backed cryptocurrency” is issued with 100 crypto-coins “tokens” are linked to 1 ounce of 24 karat gold. Of this gold, ⅓^{rd} is in physical gold and ⅔^{rd} is linked to the “future delivery” of 24 karat gold (for example, up to 5 years for delivery). [see FIG. 1 and FIG. 2]

The OZcoin system (known as the OZcoin Platform) provides an alternative funding mechanism for capital-intensive public (and large private) Corporations (Company). OZcoin Platform developed the first “100% asset backed cryptocurrency”, OZcoinGold, to provide an alternative funding mechanism for a capital intensive public traded gold-mine company. OZcoinGold is the first iteration of a Cryptocurrency, developed on the OZcoin Platform. OZcoinGold is “100% backed by gold”, a combination of one third (⅓) physical gold and two thirds (⅔) contract-for-future-delivery (five year) gold from a public traded gold-mine's proven gold resources. In this instance OZcoin Platform took security (lien) over all the gold-mine's assets—these assets included plant and equipment, 600,000 ounces of proven gold reserves and 10-million ounces of “assayed gold reserves”.

The first OZcoin Platform product, OZcoinGold cryptocurrency is 100% backed by gold; however, OZcoinGold is not redeemable for physical gold for a period of 5 years. [see FIG. 3 and FIG. 4]

The OZcoin Platform utilizes the blockchain and the InterPlanetary Files System (IPFS) to track these crypto-coin assets through its chain of custody. This allows for the open and public verification of the asset's existence without a centralized database.

The present invention also includes a marketing system that allows for up to 10% “affiliate commission” to be paid.

This system allows for a referral (affiliate) commission to be paid to a “referral commission wallet”, thus the “referral commission wallet” is paid directly via the blockchain when the “referral commission wallet” is used by an “affiliate” to obtain their own “wallet” and purchase OZcoin Platform issued crypto-coins “tokens”. [see FIG. 3, FIG. 4, FIG. 7, FIG. 10]

In one embodiment, the present invention is a system of managing online currency, comprising:
an issuing entity;
a cryptocurrency created by said issuing entity;
an asset associated with said cryptocurrency in an amount providing said cryptocurrency being one hundred percent asset backed by said asset;
a contract between an issuing entity and a purchaser for acquiring said cryptocurrency;
a computer program stored on a non-transitory medium configured to interact an online currency transaction between an issuing entity and a cryptocurrency purchaser;
an escrow account configured for receiving said cryptocurrency acquired by said purchaser; and
an asset storage facility storing said asset.

In one embodiment, the present invention is further comprising a delivery mechanism for physical delivery of said asset from said storage facility to said storage facility to said purchaser upon purchaser request.

In one embodiment, the present invention is further comprising a second non-asset based cryptocurrency being issued upon said physical delivery.

In one embodiment, the present invention provides said asset is a precious metal, exchange traded commodity, physical goods inventory, or combinations thereof.

In one embodiment, the present invention provides said asset is gold, silver, platinum, or combinations thereof.

In one embodiment, the present invention provides said one hundred percent asset based cryptocurreny is issued and limited to only an amount equal to and not greater than said asset value.

In one embodiment, the present invention provides said one hundred percent asset based cryptocurreny is linked to a combination of a presently available asset and an asset secured for future delivery of up to five years.

In one embodiment, the present invention is further including a referral commission wallet configured to receive an amount between 0.1-10% affiliate co fission paid directly via a blockchain when said referral commission wallet is used by an affiliate to said affiliate's own crypto currency balance.

The present invention also includes a method of managing online currency, said method comprising the steps of:
providing a system according to the disclosure herein;
issuing said cryptocurrency created by said issuing entity;
associating said asset associated with said cryptocurrency in an amount providing said cryptocurrency being one hundred percent asset backed by said asset;
providing and entering said contract between said issuing entity and said purchaser for acquiring said cryptocurrency;
providing a computer program stored on a non-transitory medium configured to interact said online currency transaction between said issuing entity and said cryptocurrency purchaser;
providing said escrow account configured for receiving said cryptocurrency acquired by said purchaser; and
providing said asset storage facility storing said asset.

In one embodiment the invention is further providing a delivery mechanism for physical delivery of the asset from said storage facility to the purchaser upon purchaser request.

In one embodiment the invention is further providing said second non-asset based cryptocurrency being issued upon said physical delivery.

In one embodiment the invention is further providing said asset is a precious metal, exchange traded commodity, physical goods inventory, or combinations thereof.

In one embodiment the invention is further providing said asset is gold, silver, platinum, or combinations thereof.

In one embodiment the invention is further providing said one hundred percent asset based cryptocurreny is issued and limited to only an amount equal to and not greater than said asset value.

In one embodiment the invention is further providing said one hundred percent asset based cryptocurreny is linked to a combination of a presently available asset and an asset secured for future delivery of up to five years.

In one embodiment the invention is further providing including a referral commission wallet configured to receive an amount between 0.1-10% affiliate commission paid directly via a blockchain hen said referral commission wallet is used by an affiliate to said affiliate's own crypto currency balance.

As used herein, the following terms are:

IPFS: is a peer-to-peer distributed file system that seeks to connect all computing devices with the same system of files. In some ways, IPFS is similar to the World Wide Web, but IPFS could be seen as a single BitTorrent swarm, exchanging objects within one Git (GIT: see below) repository. In other words, IPFS provides a high-throughput, content-addressed block storage model, with content-addressed hyperlinks. This forms a generalized Merkle directed acyclic graph (DAG). IPFS combines a distributed hash table, an incentivized block exchange, and a self-certifying namespace. IPFS has no single point of failure, and nodes do not need to trust each other. Distributed Content Delivery saves bandwidth and prevents DDoS attacks which HTTP struggles with.

Access: The file system can be accessed in a variety of ways, including via FUSE and over

HTTP. A local file can be added to the IPFS filesystem, making it available to the world. Files are identified by their hashes, so it's caching-friendly. They are distributed using a BitTorrent-based protocol. Other users viewing the content, aid in serving the content to others on the network. IPFS has a name service called IPNS, a global namespace based on PKI, serves to build trust chains, is compatible with other NSes and can map DNS, .onion, .bit, etc. to IPNS.

Git (/git/) is a version control system (VCS) that is used for software development [7] and other version control tasks. As a distributed revision control system it is aimed at speed, data integrity, and support for distributed, non-linear workflows. Git was created by Linus Torvalds in 2005 for development of the Linux kernel, with other kernel developers contributing to its initial development. As with most other distributed version control systems, and unlike most client—server systems, every Git directory on every computer is a full-fledged repository with complete history and full version tracking abilities, independent of network access or a central server.

Merkle data format: Every Merkle is a directed acyclic graph (DAG) because each node is named by a hash algorithm (a one-way function) which prevents cycles. Each branch of Merkle is the hash of its local contents, naming children by their hash instead of their full contents.

In general for any Merkle, to create a new branch or verify an existing branch, a hash algorithm is used on some combination of the local contents, such as a list of child hashes and other bytes.

### BRIEF DESCRIPTION OF THE SEVERAL VIEWS OF THE DRAWINGS

FIG. 1 is an overview flow chart of the system and method according to one embodiment of the present invention depicting the life cycle.

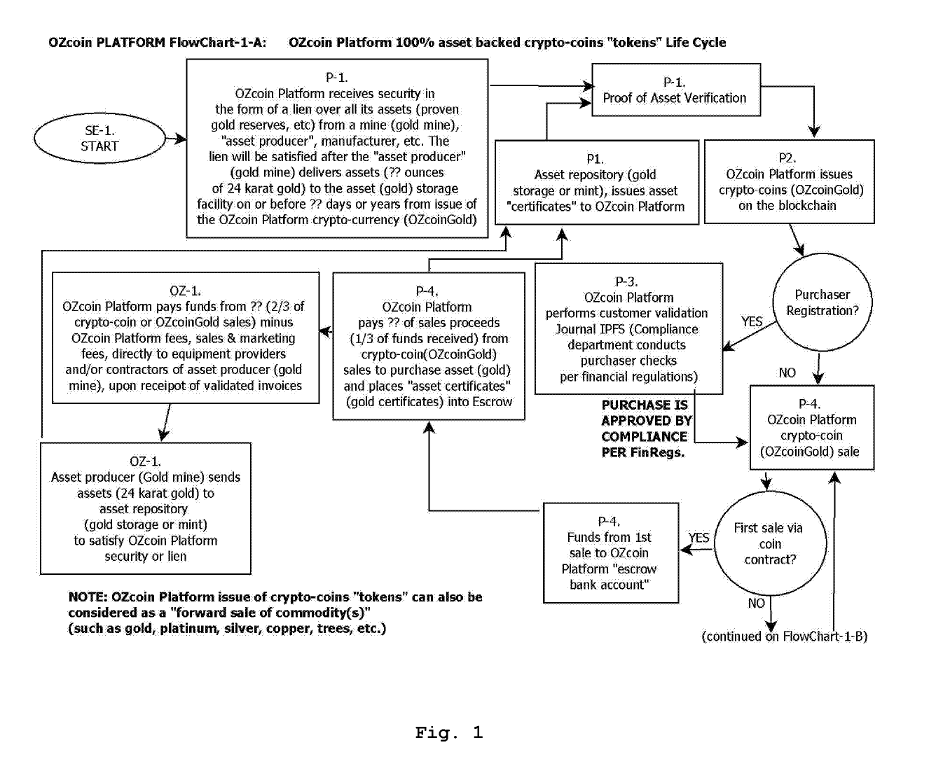

FIG. 2 is a flow chart of one proof-of-asset verification process of the system and method according to one embodiment of the present invention continued from FIG. 1.

FIG. 3 is a flow chart of the system and method according to one embodiment of the present invention demonstrating the proof of asset validation.

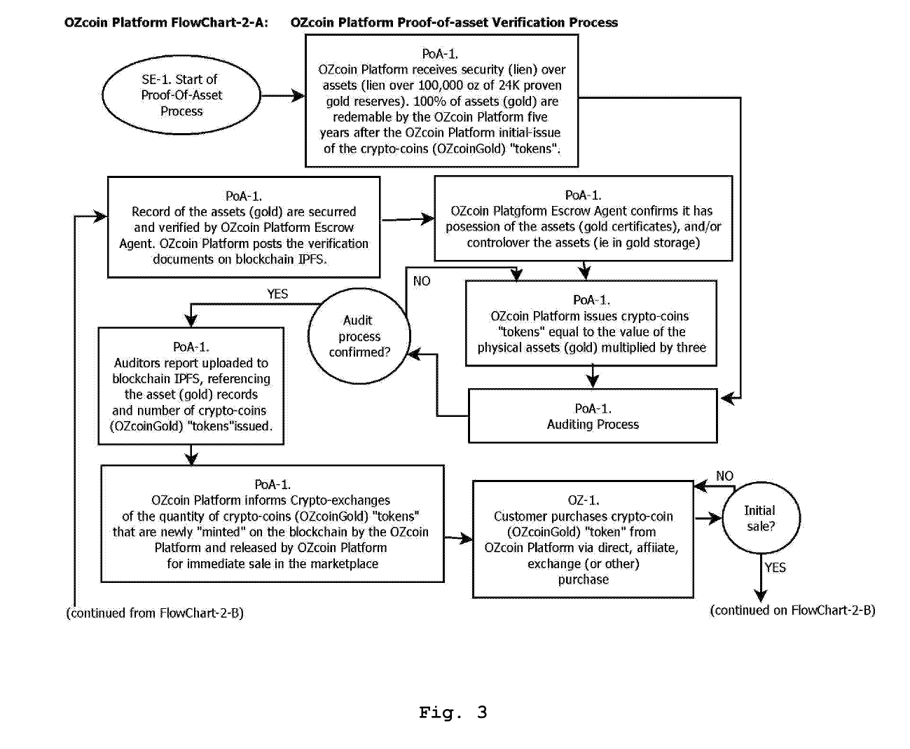

FIG. 4 is a flow chart of the system and method according to one embodiment of the present invention demonstrating the proof of asset validation continued from FIG. 3.

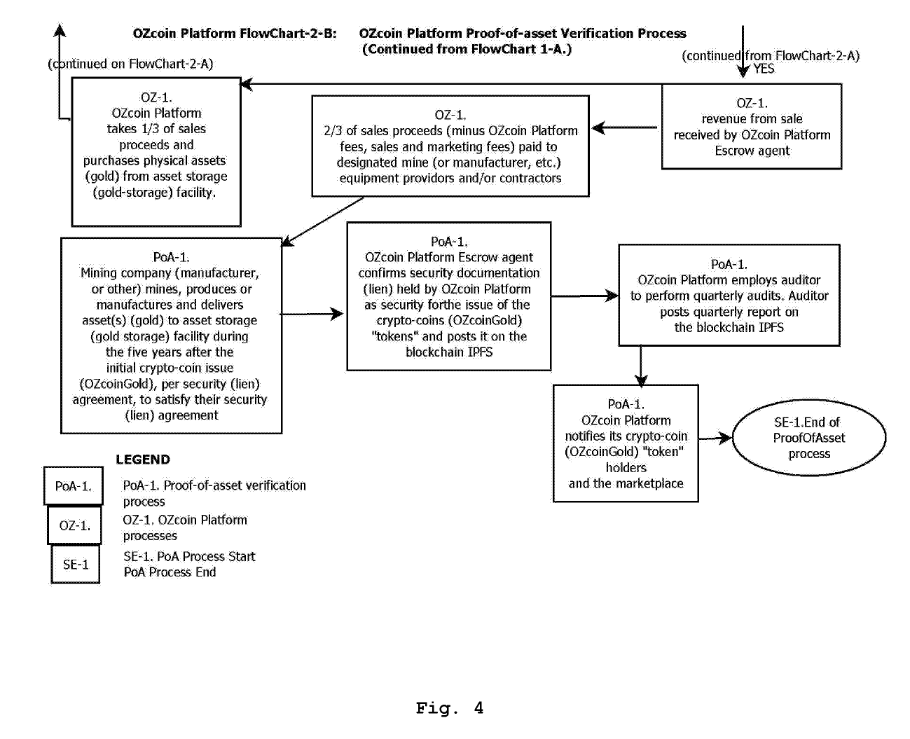

FIG. 5 is a flow chart of the system and method according to one embodiment of the present invention demonstrating an audit process.

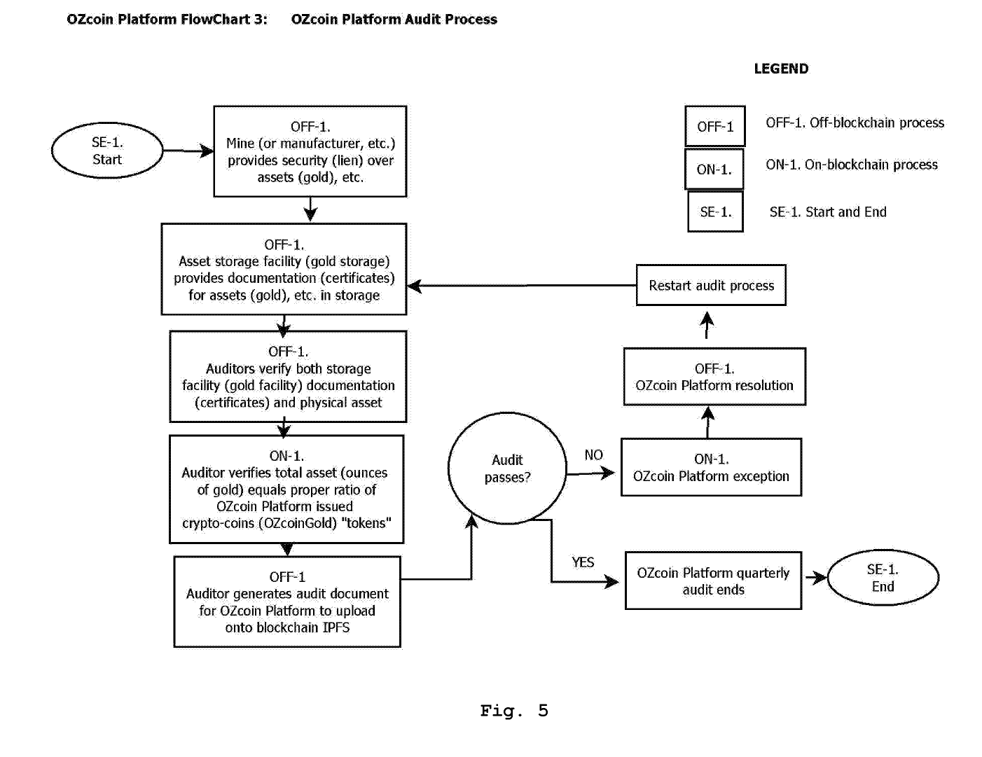

FIG. 6 is a flow chart of the system and method according to one embodiment of the present invention demonstrating a minting process.

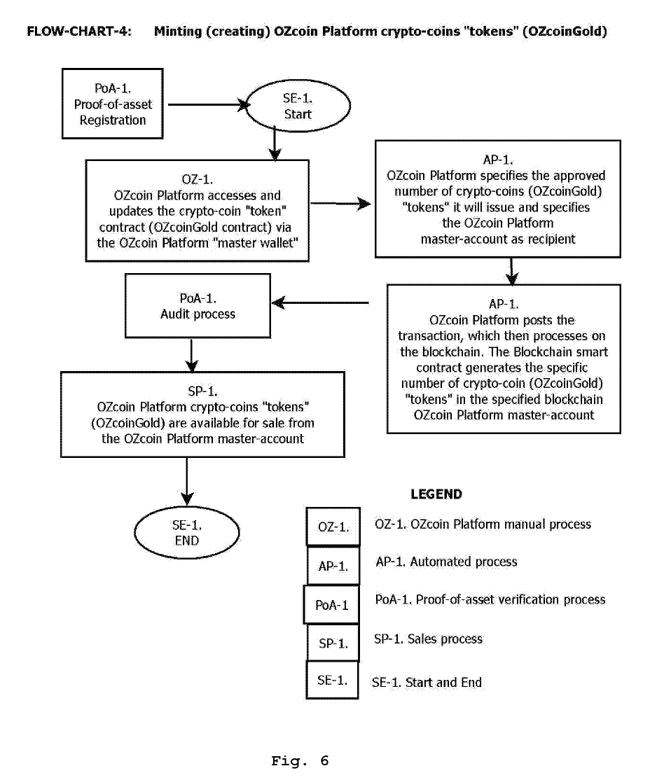

FIG. 7 is a flow chart of the system and method according to one embodiment of the present invention demonstrating a platform sales process.

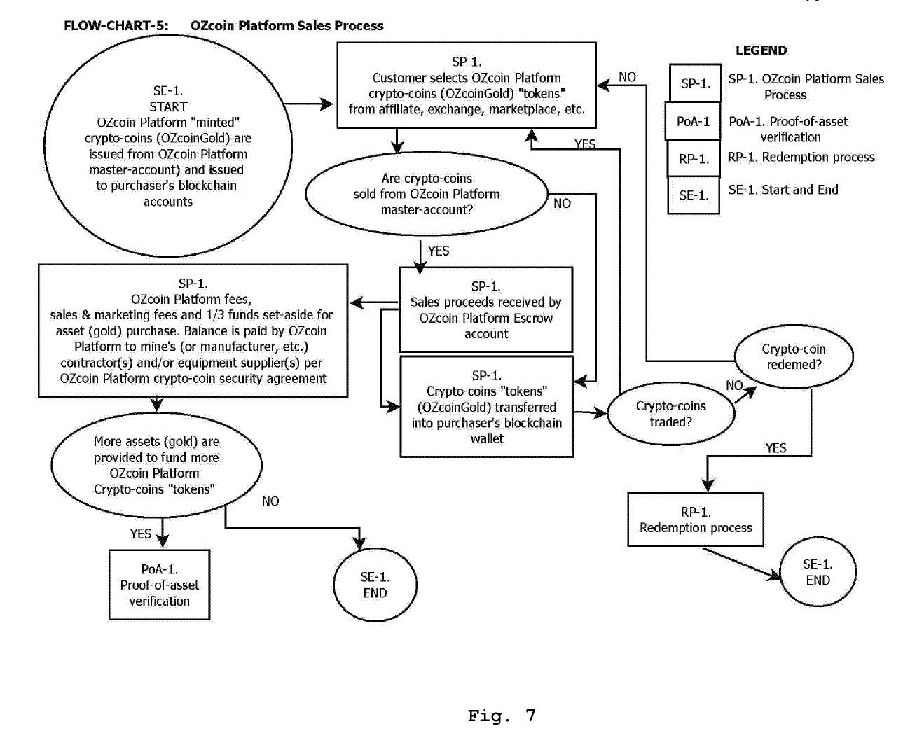

FIG. 8 is a flow chart of the system and method according to one embodiment of the present invention demonstrating a redemption process.

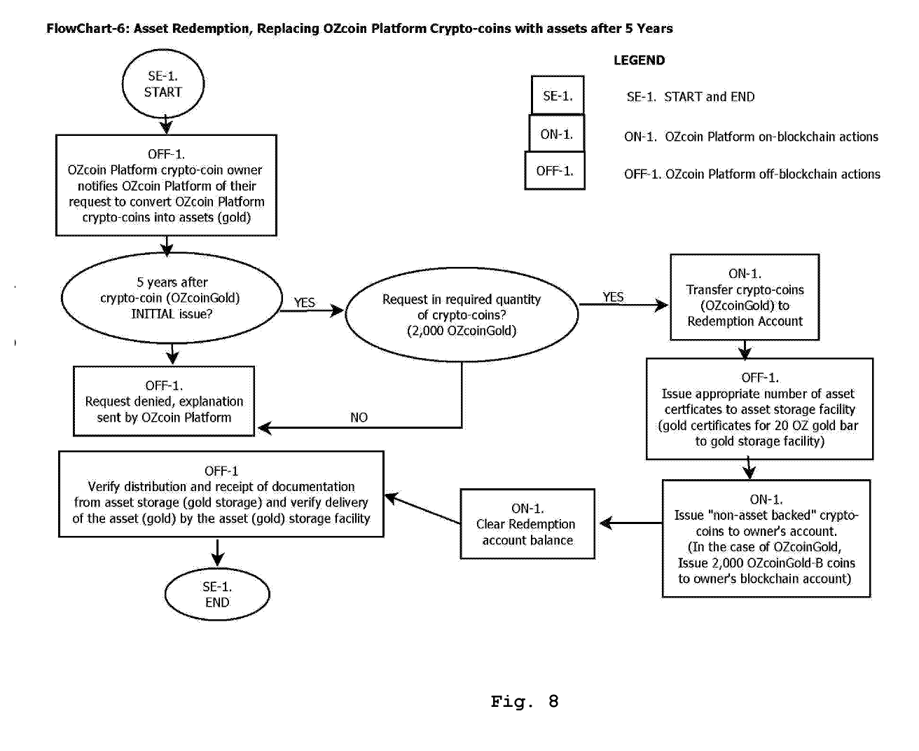

FIG. 9 is a flow chart of the system and method according to one embodiment of the present invention demonstrating an arbitration process.

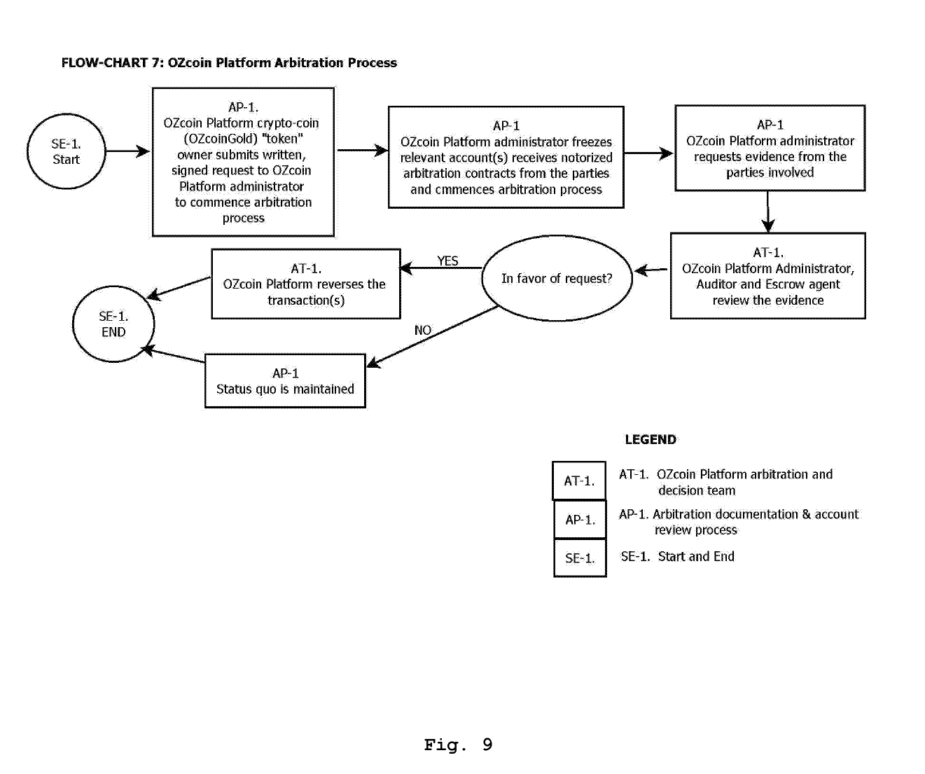

FIG. 10 is a flow chart of the system and method according to one embodiment of the present invention demonstrating an issuing process.

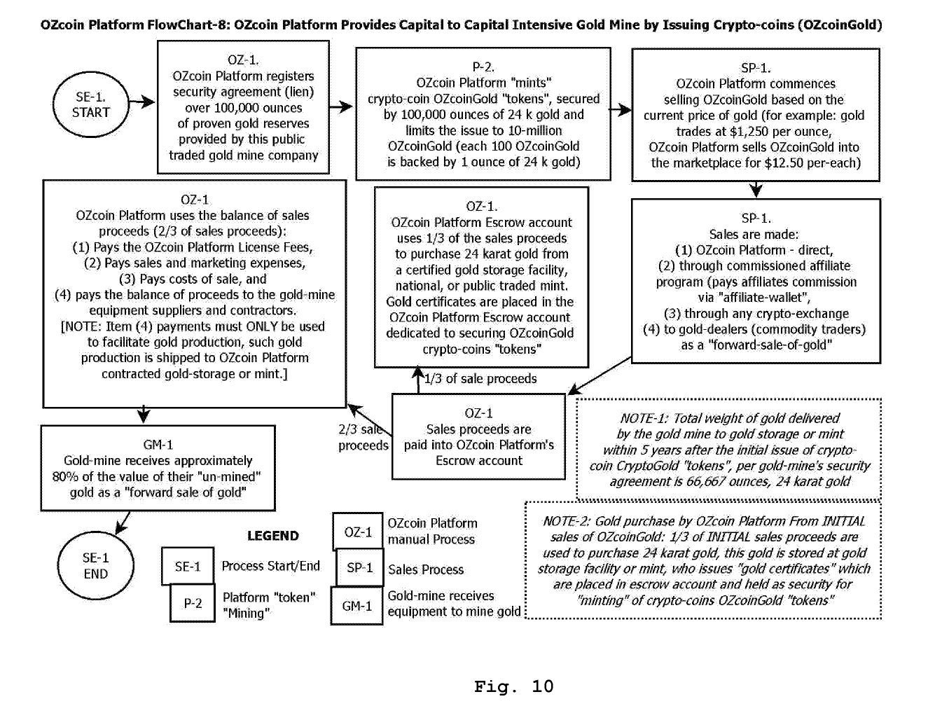

FIG. 11 is a flow chart of the system and method according to one embodiment of the present invention demonstrating a life cycle process.

FIG. 12 is a flow chart of the system and method according to one embodiment of the present invention demonstrating a life cycle process continued from FIG. 11.

### DETAILED DESCRIPTION OF THE PREFERRED EMBODIMENT

In one embodiment, the present invention is a system and method embodied in an OZcoin platform.

The OZcoin Platform incorporates several key products and services.

The OZcoin Platform Portal is one of possibly many distribution tools. It is simply a web app through which any other website or web app could be reached via PHP, html or JavaScript and is designed for “smart phones”, tablets and computers. The “Portal” app provides OZcoin Platform crypto-coin owners to (1) access OZcoin Platform to download an OZcoin Platform “wallet” and register to purchase OZcoin Platform issued crypto-coins and/or redeem OZcoin Platform asset-backed crypto-coin's asset backing, (2) track, sell and trade crypto-coins, (3) access various cryptocurrency exchanges, and (4) track crypto-coin prices.

OZcoin Platform crypto-coins are Minted (issued) via the OZcoin Platform's central administration account on the blockchain. In the first iteration OZcoin Platform's OZcoinGold, every 100 OZcoinGold crypto-coins represent one ounce of 24 karat gold of which one third is physically stored in a Gold Repository or Mint and two thirds are part of the OZcoin Portal's security agreement contract with a public traded gold-mine's proven, registered reserves. Proof of Asset for both these are as per the Proof of Asset (PoA) process described below. OZcoin Platform's OZcoinGold Cryptocurrency is one hundred percent (100%) backed by gold and each crypto-coin is redeemable for physical gold five (5) years after issue, namely 10 Mar. 2022 (five years from the date that the first OZcoin Platform crypto-coins are issued). The resource backing the currency consists of two components:

1. A portion (for example one third) of the resource is in the form of 24 karat gold that is stored at a OZcoin Platform “escrow” Gold Repository or Mint with gold certificates issued by the Gold Repository or Mint as proof of backing by 24 karat gold. The certificates are kept in escrow by OZcoin Platform's escrow agent and audited quarterly for asset verification. The auditor verifies that the certificate(s) are backed by the physical asset. The auditors verify the “asset” certificates (gold certificates) are backed by the physical “asset” (gold).

2. The balance (for example two thirds) of the asset (gold) forms part of the asset provided by the “asset” Company's proven asset reserves (gold mine's gold reserves) and resources (in the case of OZcoinGold, the gold-mine's gold reserves in accordance with the appropriate JORC Reporting code 2012). This portion of the asset (gold) will be extracted and processed over a period of one to five years from the date of the release of the first OZcoin Platform crypto-coin, OZcoinGold. At which point one hundred percent (100%) of the physical asset (gold) is redeemable via the OZcoin Platform. As Proof-of-Asset the storage facility (gold storage or Mint) issues certificates (gold certificates) and the gold-mine issued security (a lien) to the OZcoin Platform over some or all its assets. The lien is discharged by the delivery of the required asset (100,000 ounces 24 karat gold) to the OZcoin Platform “escrow” gold storage facility or mint. So, the future redemption date of the asset (gold) is 10 Mar. 2022. In the case of OZcoinGold, as gold extraction progresses at the gold-mine, the mine delivers 24 karat gold to the escrow Gold Repository or Mint and the escrow Gold Repository or Mint issues 24 karat gold certificates, these certificates, when 100,000 ounces of gold are so stored, will satisfy the gold mine's security (lien). Quarterly audits will be conducted to confirm (1) Asset repository (Gold Repository or Mint) certificates are current and backed by 24 karat gold, and (2) additional asset certificates (Gold Repository or Mint certificates) are issued by the escrow Gold Repository or Mint after delivery of gold by the asset provider (gold-mine)—these certificates will accumulate to satisfy the security (lien) over the asset provider (gold mine) assets. All asset (gold) certificates will be maintained and recorded by the OZcoin Platform escrow agent.

OZcoin Platform crypto-coins are accessed in blockchain accounts via specified OZcoin Platform blockchain wallets (and other accepted crypto-wallets).

There are FIVE modular processes that the OZcoin Platform uses to provide proof of existence and fungibility for the assets in question and to ensure compliance of the OZcoin Platform with future international and US cryptocurrency regulations. These processes are: The Proof-of-Assets (PoA) Verification process, wherein the auditing process is a sub-part of the Proof-of-Asset Verification Process; the OZcoin Platform Minting Process; the Customer Registration, OZcoin Platform Information Capturing Process and regulation compliance process; the OZcoin Platform Sales Process; redemption, whereby the redemption process through which OZcoin Platform crypto-coins can be redeemed for physical gold, and further whereby the process through which replacement OZcoin Platform coins, in the first iteration known as OZcoinGold-B coins, will be issued.

The Proof of Asset (PoA) Verification process records and provides an audit trail of the relevant assets backing the issued OZcoin Platform crypto-coins. The crypto-coins' authenticity and correct asset value backing are certified using sequential digital signatures from the entities in the chain of custody, namely, the asset provider (in the first instance a gold-mine), asset repository (Gold Repository or Mint), OZcoin Platform Escrow Agent and Independent Auditor, which are further validated with proof of delivery to the asset repository (Gold Repository or Mint) through the issue of asset “certificates” provided by the asset storage (Gold Storage or Mint) facility. These issued asset (gold) certificates are uploaded onto the blockchain for permanent record.

FlowChart-2-A and 2-B: OZcoin Proof-of-Asset Verification Process

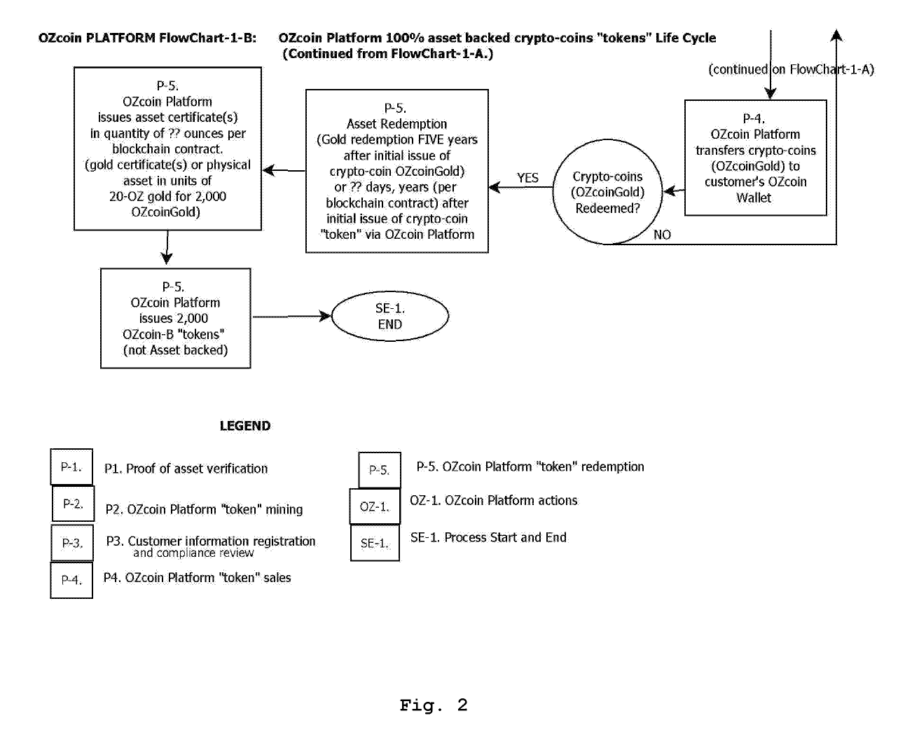

The Proof of Asset (PoA) Verification contains a sub-process for regular audits as shown in (FIG. 2).

FlowChart-3: Audit Process

2. The OZcoin Platform Crypto-Coin Minting Process

The OZcoin Platform's OZcoinGold cryptocurrency denomination breakdown looks as follow:

| Denomination | Value in OZC | Value in Dollar | OZ of Gold |
|---|---|---|---|
| ozOZcoinGold | 100 | $1,250.00 | 1 oz |
| OZcoinGold | 1 | $12.50 | 0.01 oz |
| mOZcoinGold | 0.001 | $0.0125 | 0.00001 oz |
| uOZcoinGold | 0.000001 | 0.00001 | 0.00000001 oz |

FlowChart-4: Minting (creating) OZcoin Platform Crypto-coins “Tokens” Customer Registration & Crypto-coin “Token” Information Capturing

This process will include the registration of personal information and review by the OZcoin Platform's regulation COMPLIANCE department, per Know Your Customer (KYC). This information is kept in OZcoin Platform's separate blockchain contract.

As part of the OZcoin Platform the following information will be permanently uploaded onto the IPFS and blockchain
Time Stamp of crypto-coin creation
SKU of the “asset certificate” (“Gold certificate”)

“Asset certificate (“Gold certificate”) serial numbers [NOTE: portions of these “serial numbers” may be redacted to prevent duplication; however, the OZcoin Platform Auditor and Escrow agent will verify each certificate]
Chain of Custody digital signatures (Vendor, Custodian, Auditor)
Audit Documentation
Asset storage (Gold storage or Mint) Depository Receipt asset certificate (“Gold certificate”)

4. The OZcoin Platform Crypto-coin “Token” Sales Process FlowChart-5: The OZcoin Platform Sales Process

5. OZcoin Platform Crypto-coin “Token” Redemption Process Redemption Smart Contract, which is used to exchange OZcoin Platform crypto-coins “tokens” into asset certificates (Gold certificates) issued by asset repository (Gold Repository or Mint). In the case of OZcoinGold there certificates are redeemable into 20 oz, 24 karat cast-gold bars (FlowChart-6).

FlowChart-6: OZcoin Platform Asset Redemption, Replacing OZcoin Platform Crypto-coins with Assets after 5 Years

Key Contracts and Elements

The following main contracts are required: Customer registration contract (IPFS); OZcoin Platform Contract; OZcoin Platform Transaction contract; OZcoin Platform Wallet; OZcoin Platform Redemption contract

“Registering” to purchase OZcoin Platform crypto-coins is required to be reviewed by OZcoin Platform's compliance department. Registration is also a mechanism through which OZcoin Platform crypto-coin owners can receive newsletters and other information and communication regarding OZcoin Platform crypto-coins. All customer information is kept on the IPFS.

The OZcoin Platform Crypto-coin Contract and in one embodiment consists of the following functions: Set the Contract owner as OZcoin Platform; Set OZcoin Platform and ONLY OZcoin Platform as Central Contract Administrator; Set the initial balance as zero; Have a conditional

Transfer function—Set with a modifier; Enable or Minting of additional crypto-coins “Tokens” by OZcoin Platform and OZcoin Platform only; Enable or Minting to the OZcoin Platform crypto-coin account only; Enable OZcoin Platform, after discussion with the Auditor, to freeze/unfreeze specified accounts; Enable an arbitration process; Enable automatic selling and buying from accounts by setting a price in a crypto-coin, USD, Euro, etc; Charge a % transaction fee in uOZcoinGold every time a Token is transferred from one account to another. This fee is to be paid into the contract account or an account that can be set as OZcoin Platform Administrator.

Flow-Chart 7—OZcoin Platform Arbitration Process 3. OZcoin Platform's Crypto-coin Transaction Contract

This contract needs to capture and display the following information:

All the accounts outgoing OZcoin Platform crypto-coin transactions—Send to which account

All the accounts incoming OZcoin Platform crypto-coin transactions—Received from which account

Time stamp of all transactions OZcoin Platform transaction fees for each transaction.

4. OZcoin Platform Wallet

The OZcoin Platform crypto-coins are based on the blockchain “token” API so that it will work with OZcoin Platform and other blockchain compatible wallets. It is therefore perceived that OZcoin Platform Wallet (or other approved wallets) would be the acceptable desktop wallets. Numerous Android and IOS wallets exist for blockchain and could be optional; however, OZcoin Platform's wallet will provide its crypto-coin owners “additional benefits” for use of the OZcoin Platform wallet.

5. OZcoin Platform's Crypto-coin Redemption Contract

When OZcoin Platform crypto-coins are redeemed, they will be transferred into this account. No OZcoin Platform crypto-coin transfers can take place from this account. When customer redemption is confirmed and approved in the blockchain contract, OZcoin Platform removes that number of OZcoin Platform crypto-coins from its balance and creates an equal number of OZcoin Platform-B coins (OZcoinGold-B) “tokens” that are assigned to the correct account. OZcoin Platform Crypto-coin Proof-of-Asset Participants

Asset Vendor

Asset storage and/or vendor (Gold Repository or Mint), preferably publicly listed companies, supply specified assets (Bullion) to Markets and, in the instance of OZcoinGold, they provide certified gold bullion bars through the Bullion Marketplace. The asset repository (Gold Repository or Mint) is chosen because they can be innovative precious metals enterprise, providing premium gold, platinum, silver, coins, etc. and other products and services to markets throughout the world.

Independent Auditor

OZcoin Platform Auditors will carry out quarterly checks on the asset-certificates (“Gold certificates”) provided by the asset repository (Gold Repository or Mint) to ensure accounting is upheld and the certificates are backed by the physical asset (such as gold, platinum, silver, etc.). Auditors are chosen as a multinational group with capabilities in an extensive range of assets and commodities, providing independent inspection, sampling and testing services of asset (gold) certificates.

Blockchain is a Multiparty Trust Mechanism

The OZcoin Platform blockchain relies on multiple independent participants to provide a transparent platform for the tokenization of physical assets. OZcoin Platform assumes that miners in a Proof-of-Work based cryptocurrency system will act rationally, that is, that they would act in a way to maximize and protect their long-term profits by performing their role of transaction verification.

Key Benefits

No centralized database management of Crypto-Asset records

All chain of custody information is fully managed by the blockchain. The newer blockchain ledgers are immutable with data upload taking significantly less time than on the Bitcoin blockchain.

In a preferred embodiment, there is no web form log-in. Users will download desktop, phone or smart-wallet clients from the OZcoin Platform. There is significantly less chance of a “Man in the Middle” attack compared to traditional user web-based log-in.

Perpetual Existence of Digital Assets

All asset data is recorded on the blockchain and exists indefinitely. Every proof generated can be verified and are admissible in a court of law in the applicable jurisdiction.

Ex-post facto Incentivization Mechanism

The Proof-of-Asset process requires that regular quarterly audits to be performed by a 3rd party auditor on the entire collection of (gold) assets held at the escrow custodian vaults. The auditor performs a complete audit of asset certificates (gold certificates) from the asset repository (Gold Repository or Mint), which includes verification of authenticity and physical examination to detect anomalies or defects.

The Auditor

Submits a record on the asset repository (Gold Registry or Mint) contract for each and every single asset certificate (gold certificate) that has been audited, which contains an IPFS reference to signed paper documentation, the auditor's blockchain identity, and a pass or fail result. OZcoin Platform receives its revenues through the collection of transaction fees paid in the form of acceptable crypto-coins “tokens” as well as sales transaction “fees” and “licensing fees” from the entity seeking capital (and/or gold-mine).

Wealth Inheritance

Dead man's switch can be built as a service to allow wealth to be passed on in the form of Crypto-Assets to the mentioned blockchain address under the OZcoin Platform.

Escrow

OZcoin Platform crypto-tokens can provide a better and less volatile store of value for Escrow services on the blockchain.

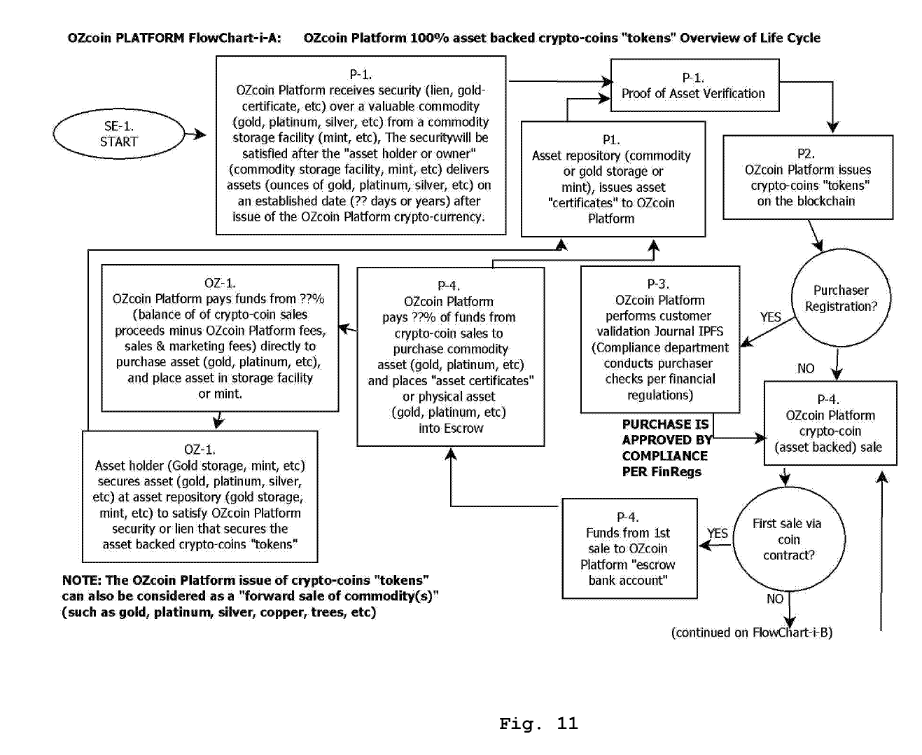

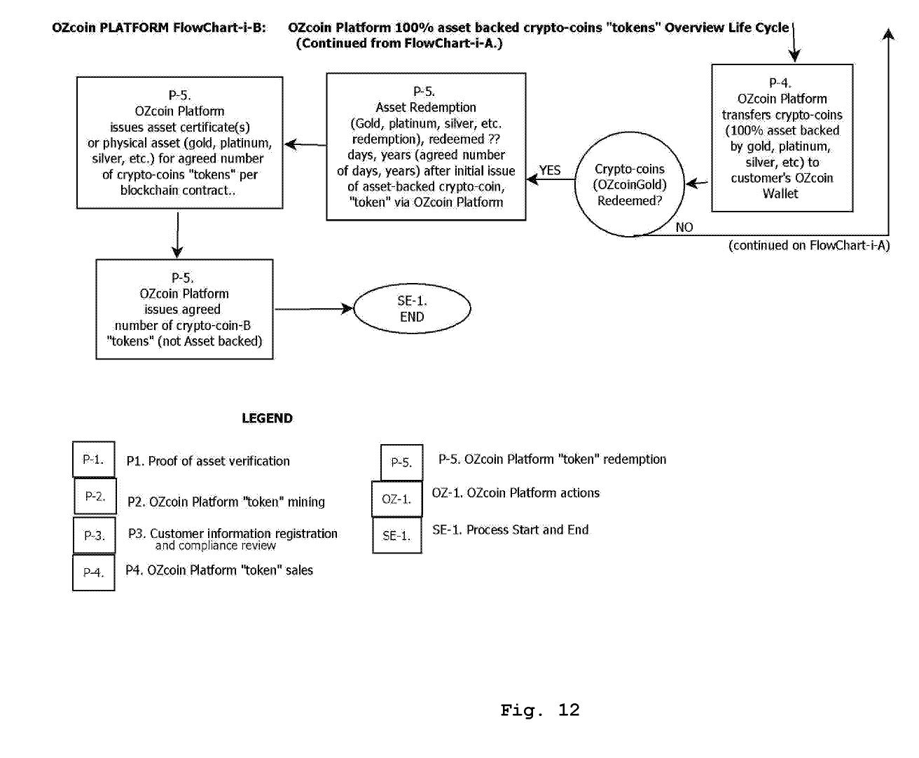

Capital Raising [see FIG. 11 and FIG. 12]

OZcoin Platform provides a decentralized app (Dapp) to provide capital raising for capital intensive companies (mining, commodity, manufacturing, etc. companies) seeking capital by pledging assets to OZcoin Platform's crypto-coins. Further, OZcoin Platform can offer convertibility of cryptocurrencies to crypto-coins as a hedge against price volatility.

Gold Backed Cryptocurrency Developments

Cryptocurrencies can stake a portion of its value with OZcoin Platform crypto-coins and Gold Assets, backing their value with 24 karat Gold.

The OZcoin Platform based crypto-coins provides a transparent, audit friendly, safe protocol that leverages the full potential of blockchain's decentralized consensus ecosystem and IPFS to facilitate crypto-assets on the blockchain.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A system of managing online currency, comprising:
an issuing entity;
a cryptocurrency created by said issuing entity;
an asset associated with said cryptocurrency in an amount providing said cryptocurrency being one hundred percent asset backed by said asset;
a contract between an issuing entity and a purchaser for acquiring said cryptocurrency;
a computer program stored on a non-transitory medium configured to interact an online currency transaction between an issuing entity and a cryptocurrency purchaser;
an escrow account configured for receiving said cryptocurrency acquired by said purchaser; and
an asset storage facility storing said asset.

2. The system of claim 1 further comprising a delivery mechanism for physical delivery of said asset from said storage facility to said storage facility to said purchaser upon purchaser request.

3. The system of claim 1 further comprising a second non-asset based cryptocurrency being issued upon said physical delivery.

4. The system of claim 1 wherein said asset is a precious metal, exchange traded commodity, physical goods inventory, or combinations thereof.

5. The system of claim 1 wherein said asset is gold, silver, platinum, or combinations thereof.

6. The system of claim 1 wherein said one hundred percent asset based cryptocurrency is issued and limited to only an amount equal to and not greater than said asset value.

7. The system of claim 1 wherein said one hundred percent asset based cryptocurrency is linked to a combination of a presently available asset and an asset secured for future delivery of up to five years.

8. The system of claim 1 further including a referral commission wallet configured to receive an amount between 0.1-10% affiliate com nission paid directly via a blockchain when said referral commission wallet is used by an affiliate to said affiliate's own crypto currency balance.

9. A method of managing online currency, said method comprising the steps of:
providing a system according to claim 1;
issuing said cryptocurrency created by said issuing entity;
associating said asset associated with said cryptocurrency in an amount providing said cryptocurrency being one hundred percent asset backed by said asset;
providing and entering said contract between said issuing entity and said purchaser for acquiring said cryptocurrency;
providing a computer program stored on a non-transitory medium configured to interact said online currency transaction between said issuing entity and said cryptocurrency purchaser;
providing said escrow account configured for receiving said cryptocurrency acquired by said purchaser; and
providing said asset storage facility storing said asset.

10. The method of claim 1 further providing a delivery mechanism for physical delivery of the asset from said storage facility to the purchaser upon purchaser request.

11. The method of claim 1 further providing said second non-asset based cryptocurrency being issued upon said physical delivery.

12. The method of claim 1 further providing said asset is a precious metal, exchange traded commodity, physical goods inventory, or combinations thereof.

13. The method of claim 1 further providing said asset is gold, silver, platinum, or combinations thereof.

14. The method of claim 1 further providing said one hundred percent asset-based cryptocurrency is issued and limited to only an amount equal to and not greater than said asset value.

15. The method of claim 1 further providing said one hundred percent asset-based cryptocurrency is linked to a combination of a presently available asset and an asset secured for future delivery of up to five years.

16. The method of claim 1 further providing including a referral commission wallet configured to receive an amount between 0.1-10% affiliate commission paid directly via a blockchain when said referral commission wallet is used by an affiliate to said affiliate's own crypto currency balance.
